(19) United States
(12) Patent Application Publication
(10) Pub. No.: US 2006/0232032 A1
(43) Pub. Date: Oct. 19, 2006

(54) Utility cart

(75) Inventor: Mark A. Goldberg, Lido Beach, NY (US)

Correspondence Address: GIBBONS, DEL DEO, DOLAN, GRIFFINGER & VECCHIONE, 1 RIVERFRONT PLAZA, NEWARK, NJ, 07102-5497, US

(73) Assignee: Systemax, Inc.

(21) Appl. No.: 11/107,047

(22) Filed: Apr. 15, 2005

(51) Int. Cl. B62B 3/00

(52) U.S. Cl. 280/47.35

(57) ABSTRACT

The present invention relates to a knockdown construction utility cart. In an embodiment, the utility cart includes a top shelf, a middle shelf and a bottom shelf. The top and middle shelves include a base, three sidewalls, and a side skirt. The bottom shelf includes a base and four side skirts. The cart also includes a plurality of wheels attached to the bottom shelf, a plurality of posts attached to each shelf. The posts are perpendicular to the bases of the shelves. The shelves include L-shaped attachment mechanisms configured to secure the shelves and the posts in a perpendicular arrangement so that the shelves are parallel to each other. The cart also includes a handle coupled to two of the posts.

### BACKGROUND OF THE INVENTION

1. Field of the Invention

The present invention relates to utility tray carts for transporting various items. Specifically, the present invention relates to knock-down construction portable utility cart.

2. Background

Conventional carts are manufactured from plastic or similar material. Typically, the carts include a plurality of shelves supported by perpendicular posts as well as wheels attached to the cart's bottom shelf. The shelves and the perpendicular posts are manufactured from heavy plastic to provide sufficient support for the items placed on the shelves. If thin plastic is used, then the cart is not sturdy enough for transporting of heavy items. For example, office employees often use the carts to transport computer monitors, facsimile machines, printers, and other office supplies and equipment. Such equipment is heavy and the thin plastic shelves cannot support it. Thus, thick plastic is necessary to support the above during movement.

However, thick plastic is heavy and makes the cart bulky and difficult to operate. Further, most plastic carts arrive in an assembled state in large containers. Other carts are shipped in a disassembled state. In the latter case, even though the carts are not assembled, the packages are still bulky and heavy to transport. Because the plastic is thick, it is difficult to compactly pack components of the cart into a shipping container.

The cart industry also manufactures and employs metallic carts. However, such carts are typically manufactured and shipped in an assembled form. This is because most of them have to be welded together for sturdiness. This prevents manufacturers and retailers from compactly shipping the carts.

Thus, there is a need for a cart having a metallic construction and capable of being compactly shipped. Further, there is a need for a cart that has a “knockdown construction” such that it can be easily assembled and disassembled whether for shipping or other transport. The cart can include at least two shelves mountable on perpendicular posts and having wheels attached to its bottom shelf's underside. The present invention provides such a solution.

### BRIEF SUMMARY OF THE INVENTION

The present invention relates to a knockdown construction utility cart. The cart can be used for transporting various items by an operator. The cart is easy to assemble and disassemble, and hence, has a “knockdown construction.”

In an embodiment, the utility cart includes a top shelf, a middle shelf and a bottom shelf. The top and middle shelves include a base, three sidewalls, and a side skirt. The bottom shelf includes a base and four side skirts. The cart also includes a plurality of wheels attached to the bottom shelf. It has a plurality of posts attached to each shelf. The posts are perpendicular to the bases of the shelves. The posts are attached to the sidewalls and the side skirts. The sidewalls include holding walls configured to secure the posts to the sidewalls. The shelves include L-shaped attachment mechanisms configured to secure the shelves and the posts in a perpendicular arrangement so that the shelves are parallel to each other. The L-shaped attachment mechanisms are coupled to undersides of the shelves. The L-shaped attachment mechanisms include at least one opening. The posts include post openings for attachment of the shelves to the cart. The posts are attached to the shelves using post openings and the L-shaped attachment mechanisms openings. The cart also includes a handle coupled to two of the posts. The cart can be manufactured from stainless steel. The posts and the shelves are bolted together. Screws, adhesives or other methods can be also used.

In an alternate embodiment, the present invention is a method for assembling the knockdown construction utility cart. The method includes a step receiving a top shelf, a middle shelf and a bottom shelf. The top and middle shelves include a base, three sidewalls, and a side skirt. The bottom shelf includes a base and four side skirts. The method also includes steps of mounting a plurality of wheels to the bottom shelf and attaching a plurality of posts to each of the shelves. The posts are perpendicular to the bases of the shelves. The shelves include L-shaped attachment mechanisms configured to secure the shelves and the posts in a perpendicular arrangement so that the shelves are parallel to each other. The method also includes a step of mounting a handle coupled to two of the posts.

### BRIEF DESCRIPTION OF THE DRAWINGS

In the drawings, like reference numbers indicate identical or functionally similar elements. Additionally, the left-most digit(s) of a references number identifies the drawing in which the reference number first appears.

FIG. 1 illustrates a knockdown construction utility cart, according to the present invention.

FIG. 2 illustrates an exploded view of the knockdown construction utility cart shown in FIG. 1, according to the present invention.

FIG. 3 illustrates a handle of the knockdown construction utility cart, according to the present invention.

FIG. 4 illustrates a wheel attachment to the knockdown construction utility cart's bottom shelf, according to the present invention.

FIG. 5 illustrates the knockdown construction utility cart's vertical post, according to the present invention.

FIG. 6 is a side view of the knockdown construction utility cart's shelf, according to the present invention.

FIG. 7 is a rear view of the knockdown construction utility cart's shelf, according to the present invention.

FIG. 8 is a side view of a shelf's holding ridge in the knockdown construction utility cart, according to the present invention.

FIG. 9 is a flow chart of a method for assembling the knockdown construction utility cart, according to the present invention.

### DETAILED DESCRIPTION OF THE INVENTION

The present invention relates to utility carts. Specifically, the present invention relates to a knockdown construction utility cart. The cart includes a plurality of shelves supported by vertical posts. A plurality of wheels is attached to an underside of the cart's bottom shelf. A handle is attached to two of the posts to allow an attendant to push and/or pull the cart.

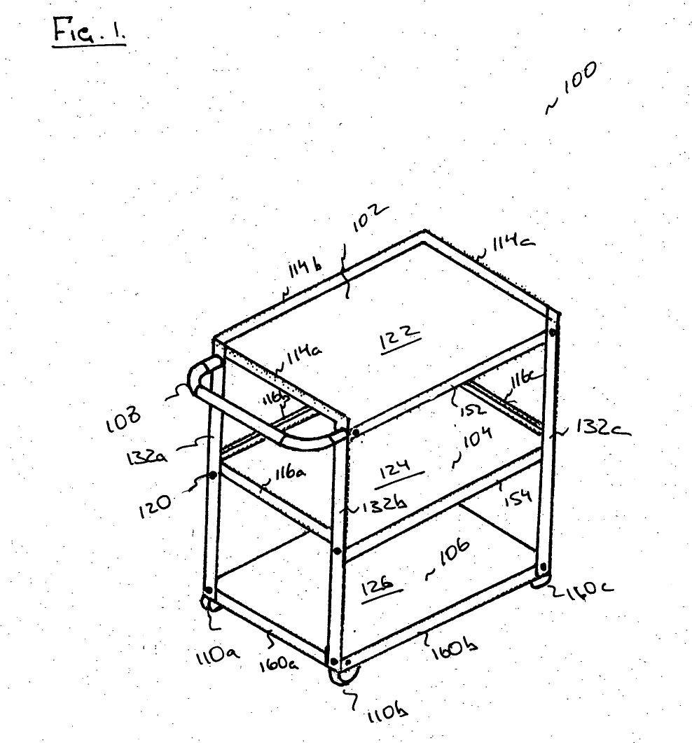

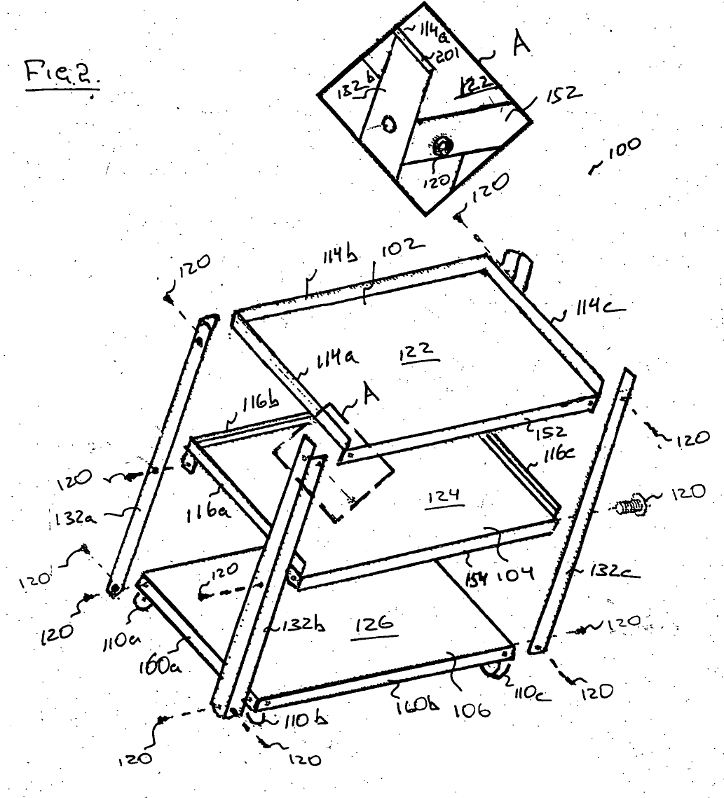

FIGS. 1 and 2 illustrate a knockdown construction utility cart 100. The utility cart 100 includes a top shelf 102, a middle shelf 104, a bottom shelf 106, vertical posts 132 (a, b, c, d), handle 108, and wheels 110 (a, b, c, d). The shelves 102, 104, and 106 are attached to vertical posts 132 (a, b, c, d) (post 132d is not show in FIG. 1) using bolts (screws, clips, adhesives or any other attachment methods) 120. The handle 108 is attached to posts 132a and 132b. The wheels 110 (a, b, c, d) are attached to an underside of the bottom panel 106 (wheel 110d is not shown in FIG. 1).

The top shelf 102 further includes upward sidewalls 114 (a, b, c) coupled to a base 122. Each sidewall is substantially perpendicular to the base 122. The sidewalls 114a and 114c are placed along the width of the shelf 102 and opposite of each other. The sidewall 114b is adjacent to sidewalls 114a and 114c and is placed along the length of the shelf 102. There is no sidewall placed opposite sidewall 114b and, instead a side skirt 152 protrudes downward and is substantially perpendicular to the base 122. The side skirt 152 allows easy placement of items onto the shelf 102. In an embodiment, an operator can slide the items on the shelf 102 from the side of the side skirt 152.

The middle shelf 104 further includes upward sidewalls 116 (a, b, c) coupled to a base 124, similarly to the top shelf 102. Each sidewall is substantially perpendicular to the base 124. The sidewalls 116a and 116c are placed along the width of the shelf 104 and opposite of each other. The sidewall 116b is adjacent to sidewalls 116a and 116c and is placed along the length of the shelf 104. There is no sidewall placed opposite sidewall 116b. The sidewall 116b of the middle shelf 104 is placed directly underneath the sidewall 114b of the top shelf 102. There is no sidewall placed opposite sidewall 116b and, instead a side skirt 154 protrudes downward and is substantially perpendicular to the base 124. Similarly to the shelf 102, an operator can use the side skirt 154 to easily place items on the shelf 104.

The bottom shelf 106 includes side skirts 160 (a, b, c, d) attached to the base 126 (the side skirts 160c and 160d are not shown in FIG. 1). The side skirts protrude downward and are substantially perpendicular to the base 126. The side skirts 160a and 160c (not shown) are placed along the width of the shelf 106 and opposite of each other. The side skirts 160b and 160d (not shown) are placed along the length of the shelf 106 and opposite of each other.

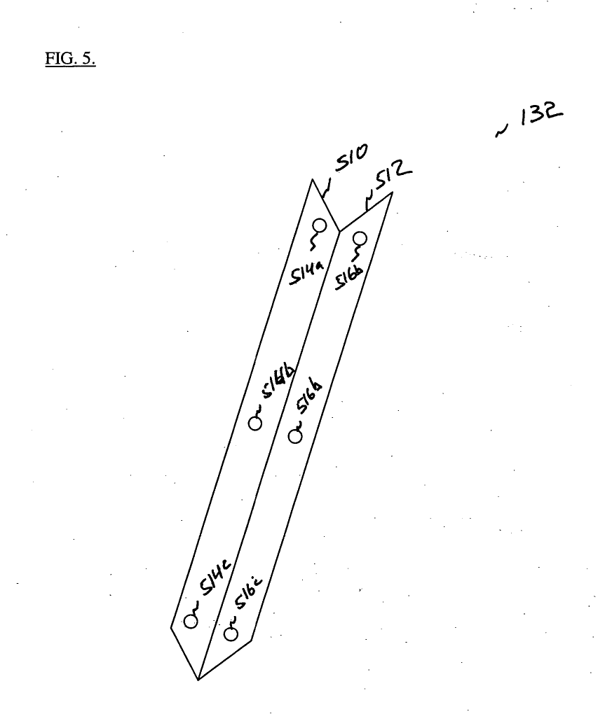

At each corner, the shelves 102, 104, and 106 are attached to posts 132 (a, b, c, d). The posts 132 have an L-shape, as shown in FIG. 5. Each post 132 further includes a left side 510 and a right side 512. The left side 510 further includes holes 514(a, b, c). The right side 512 further includes holes 516 (a, b, c). The holes 514a and 516a are located at the top of the post 132; the holes 514b and 516b are located near the middle of the post 132; and the holes 514c and 516c are located near the bottom of the post 132. The holes 514 and/or 516 accommodate bolts, screws or other securing mechanisms 120 during assembly of the cart 100.

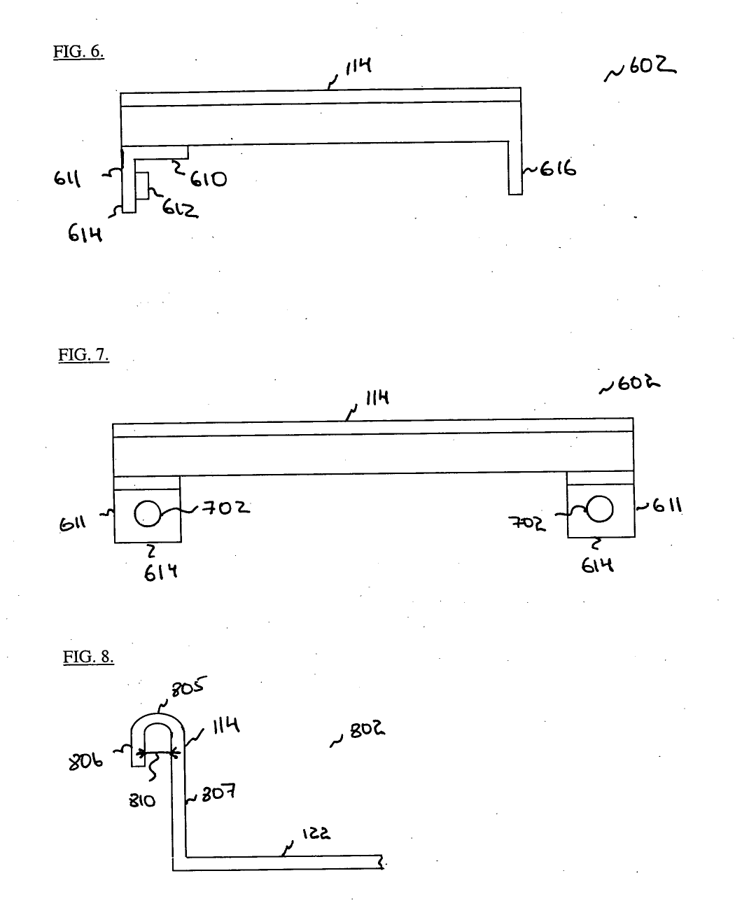

Referring back to FIGS. 1 and 2, the top shelf 102 is secured to the posts 132 using bolts 120, which are inserted through the holes 514a and 516a of the posts 132. The middle shelf 104 is secured to the posts 132 using bolts 120, which are inserted through the holes 514b and 516b of the posts 132. Similarly, the bottom shelf 106 is secured using bolts 120, which are inserted through the holes 514c and 516c of the posts 132. The shelves include a mechanism that receives bolts 120 and allows secure attachment of the shelves 102, 104, and 106 to posts 132. The mechanism is described with respect to FIG. 6.

As shown in FIG. 6, a shelf 602 (similar to shelves 102, 104, and 106) includes an L-shaped support 611 having an upper portion 610 and a perpendicular portion 614 coupled in a vertical arrangement to the upper portion 610. The upper portion 610 is attached to an underside of the shelf 602 either by welding, gluing, or any other method. In an embodiment, the L-shaped support 611 further includes a security mechanism 612. The mechanism 612 can include an inner thread, a magnet, a temporary adhesive, or any other way for coupling bolts, screws, pins, or other devices 120.

To couple the shelf 602 to the post 132, the bolts 120 are inserted through the holes 514 or 516 of the post 132, then the bolts 120 are inserted into holes 702, which are aligned with the holes 514 (as shown in FIG. 7), and are secured by the mechanism 612. Hence, the post 132 and the shelf 602 (similar to shelves 102, 104, and 106) are secured together. In an alternate embodiment, the posts 132 can be attached to shelves 102, 104, and 106 using holes 516 or using holes 514 and 516. In yet another alternate embodiment, the posts 132 can be attached directly to side skirts 152, 154, and 156, as well as, sidewalls 114 and 116 using holes 514 and/or 516, without using mechanisms shown in FIG. 6. FIG. 2 illustrates an exemplary attachment of a post 132 to the shelf 102.

In FIG. 2, an exert A illustrates the shelf 102 attached to the post 132b. Since the front of the shelf 102 includes a side skirt 152, the post 132b directly attaches to the side skirt 152. Using bolts 120, the post 132b is secured to the side skirt 152. In an embodiment, the side skirt 152 is placed on top of a left side of the post 132b, and a right side of the post 132b is placed on top of the sidewall 114a. In an alternate embodiment, the post's 132b right side can be additionally secured by a holding wall 201 of the side wall 114a.

The holding wall 201 is a part of the sidewall 114a that is bent 180 degrees away from the base 122 of the shelf 102. Thus, the holding wall 201 defines a narrow passage between the sidewall 114b and the holding wall 201. The passage is configured to hold the post 132b between two walls. The holding wall 201 is further described in FIG. 8 below.

In an embodiment, in order to accommodate varying heights of the sidewalls 114 and side skirts 152, the posts' 132 right sides can be longer than their left sides. In an alternate embodiment, the right and left sides can have equal lengths.

The middle shelf 104 is similarly attached to the posts 132. The posts 132 are placed on top of the sidewalls 116 and the side skirt 154. The bottom shelf 106 is likewise attached to the posts 132. The posts' 132 right and left sides are placed on top of respective side skirts 160. The posts 132 are attached directly to the side skirts 160 using bolts 120 (without additional mechanisms shown in FIGS. 6 and 7). In an alternate embodiment, the bottom shelf 106 includes similar mechanisms shown in FIGS. 6 and 7 in order to secure the shelf 106 to the posts 132.

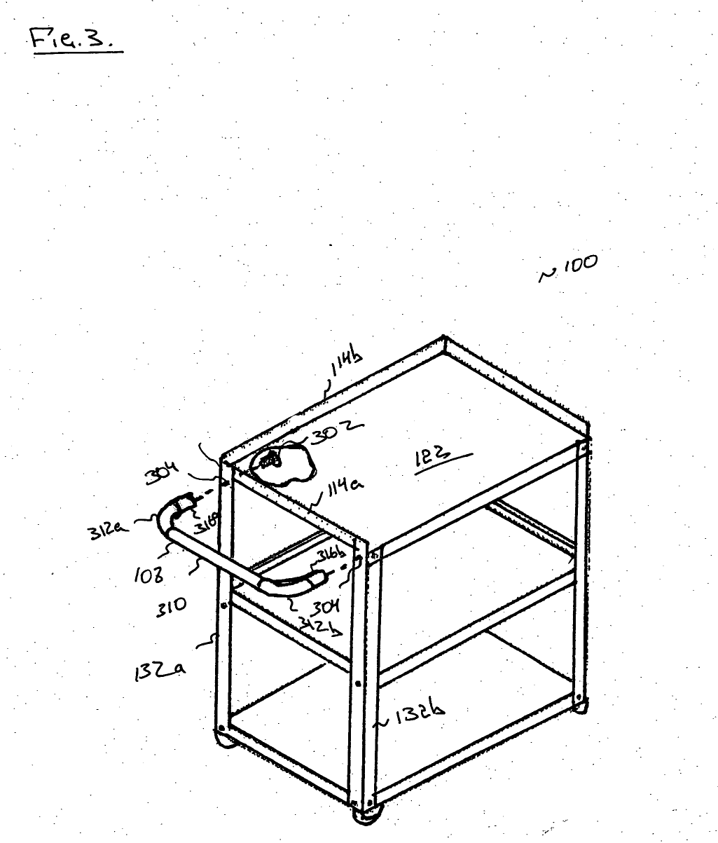

FIG. 3 illustrates the handle 108 attached to the posts 132a and 132b. The handle 108 includes an operator holding portion 310, two curved portions 312a, 312b attached to the holding portion 310, and two cart attachment portions 316a, 316b attached to the respective curved portion 312a, 312b. The attachment portions 316a, 316b are attached to the posts 132a, 132b, respectively. The handle 108 is attached using bolts (or screws, glue, or any other conventional mechanism) 302, which are inserted in openings 304 in posts 132a and 132b. The bolts 302 are then secured to the handle attachment portions 316a and 316b. As can be understood by one having ordinary skill in the relevant art, the handle 108 can be attached to other combinations of posts 132 (a, b, c, d).

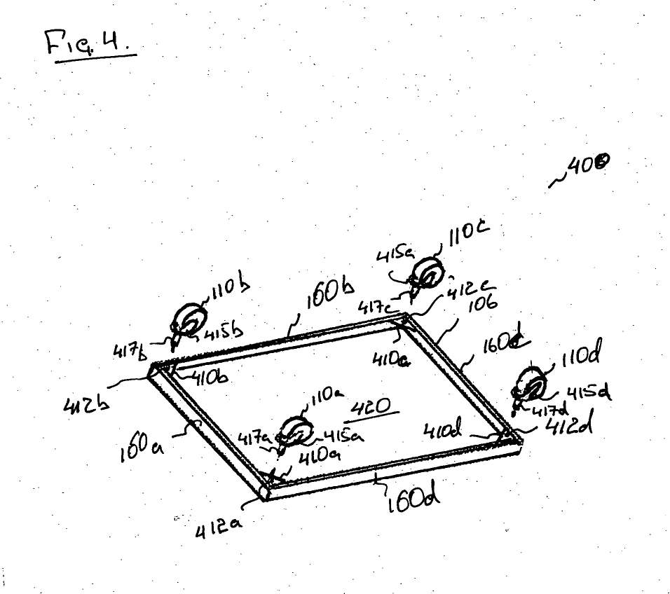

FIG. 4 illustrates a bottom shelf's 106 assembly 400 for attachment of wheels 110 (a, b, c, d). The wheels 110 are mounted to an underside 420 of the bottom shelf 106. The wheels are further mounted in the corners of the underside 420. Corner wheel platforms 410 (a, b, c, d) are attached at a junction of side skirts 160 (a, b, c, d). For example, a corner platform 410a is attached at a junction of side skirts 160a and 160d. The platform 410a is used for attachment of the wheel 110a. Further, openings 412 (a, b, c, d) are made in respective platforms 410 (a, b, c, d). The wheels 110 (a, b, c, d) include respective conventional holding structures 415 (a, b, c, d) with respective protrusions 417 (a, b, c, d). The protrusions 417 (a, b, c, d) are inserted into respective openings 412 (a, b, c, d) and secure respective wheels 110 (a, b, c, d) to platforms 410 (a, b, c, d). As can be understood by one having ordinary skill in the relevant art, the wheels 110 can be attached to the bottom shelf 106 by welding, gluing, or other methods.

FIG. 8 illustrates a portion 802 of a shelf 102. The portion 802 can be a portion of a side wall 114 (a, b, c). Further, the portion 802 includes a sidewall portion 807, a curved portion 805 and a holding wall 806 (similar to the wall 201 of FIG. 2). The holding wall 806 and the sidewall portion 807 are separated by a distance 810. The distance 810 can be equivalent to a diameter of the curved portion 805. It is configured to fit right or left sides of the posts 132. The sidewall portion 807 is adjacent to the base 122 of the shelf 102. The holding wall 806 is located opposite the base 122 with respect to the sidewall portion 807.

As stated above, the distance 810 is wide enough to accommodate insertion of the posts' 132 right or left sides between the holding wall 806 and the sidewall portion 807 (not shown in FIG. 8). When posts' 132 sides are inserted between the wall 806 and the portion 807, the cart 100 becomes more stable and less likely to fall apart due to vibrations and disturbances during motion as well as stability during loading and unloading of heavy objects. As can be understood by one having ordinary skill in the relevant art, other sidewalls 116 as well as side skirts 154, 156, and 160 (a, b, c, d) can include a similar arrangement shown in FIG. 8 to make the cart 100 more stable and rigid.

Because of the above described cart's configuration, the cart 100 can be easily assembled and disassembled, and hence, referred to as a “knockdown construction” cart. In a disassembled state, the cart's shelves 102, 104, and 106 can be easily stacked together because a right-angle shape of their sidewalls and side skirts. Similarly, the posts right-angle configuration allows easy stacking as well. Hence, in a disassembled state, the cart is very compact and easy to ship. Further, the assembly and disassembly is fast and easy, as will be illustrated by the method below.

The cart can be manufactured from any metallic material, such as iron, stainless steel, aluminum, and others. In an embodiment, the metallic material has added rigidity and is capable of supporting heavy items placed on the cart. The wheels can be manufactured from a rubber or plastic material. The wheels are further capable of turning in any desired direction to assist an operator in maneuvering the cart 100.

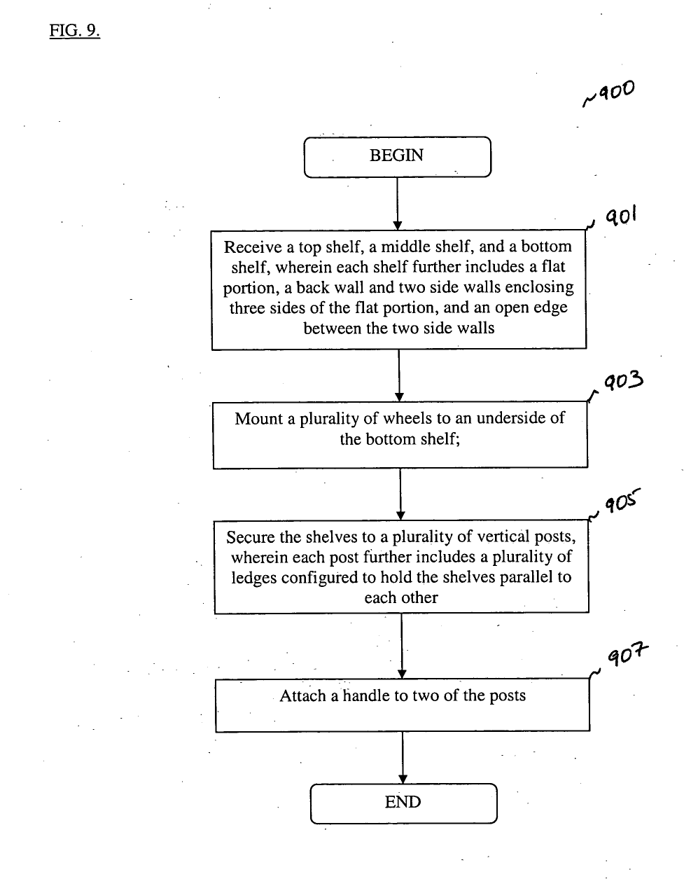

FIG. 9 is a flow chart illustrating a method 900 for assembling the cart 100 shown in FIGS. 1-8. The processing begins in step 901. In step 901, the top shelf 102, the middle shelf 104, and the bottom shelf 106 are received. As stated above, the shelves 102, 104, and 106 further include respective flat portions or bases 122, 124, and 126. The shelves 102 and 104 further include respective sidewalls 114 (a, b, c) and 116 (a, b, c) which enclose three sides of the flat portions or bases 122 and 124. The shelves 102 and 104 further include open edges located opposite sidewalls 114b and 116b, respectively, and which are between respective side walls 114a, 114c and 116a, 116c. At the open edges, the side skirts 152 and 154 are coupled to the bases 122 and 124, respectively. The bottom shelf 106 further includes side skirts 160 (a, b, c, d) and no sidewalls. The processing then proceeds to step 903.

In step 903, the plurality of wheels 110 is mounted to the underside 420 of the bottom shelf 106. The processing the proceeds to step 905.

In step 905, the shelves 102, 104, and 106 are secured to a plurality of vertical posts 132 (a, b, c, d). Each shelf 102, 104, and 106 includes plurality of L-shaped portions or ledges 611, which are configured to be attached to posts 132. The posts 132 are vertically arranged with respect to the base portions 122, 124, and 126 of the shelves 103, 104, and 106, respectively. The L-shaped portions 611 include the shelf holding portions 610 mounted to the undersides of the shelves, and the post holding portions 612, mounted to the posts 132. The portions 610 and the portions 612 are substantially perpendicular to each other. Thus, the posts 132 and the shelves are substantially perpendicular to each other. In an alternate embodiment, the posts can be mounted to sidewalls 114 and/or 116 and/or side skirts 152, 154, and/or 160. Because the sidewalls and side skirts are in substantially perpendicular arrangement with the bases 122, 124, and 126, the posts 132 when attached to respective sidewalls and/or side skirts will also be in substantially perpendicular arrangement with the bases. The processing then proceeds to step 907.

In step 907, the handle 108 is attached to two of the posts 132. The wheels 110 are also attached to the underside of the bottom shelf 106 of the cart 100. Hence, the cart is ready to be used by an operator.

Example embodiments of the methods and components of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed is:

1. A utility cart, comprising:
a top shelf, a middle shelf and a bottom shelf;
wherein said top and middle shelves further comprise a base, three sidewalls, and a side skirt;
wherein said bottom shelf further comprises a base and four side skirts;
a plurality of wheels attached to said bottom shelf;
a plurality of posts attached to each of said shelves, wherein said posts are perpendicular to said bases of said shelves;
wherein said shelves further comprise L-shaped attachment mechanisms configured to secure said shelves and said posts in a perpendicular arrangement so that said shelves are parallel to each other; and
a handle coupled to two of said posts.

2. The utility cart of claim 1, wherein said sidewalls are configured to protrude upwardly and perpendicular to said bases of said shelves;
wherein said side skirts are configured to protrude downwardly and perpendicular to said bases of said shelves.

3. The utility cart of claim 2, wherein said posts are attached to said sidewalls and said side skirts.

4. The utility cart of claim 2, wherein said sidewalls further comprise holding walls,
wherein said holding walls are configured to secure said posts to said sidewalls.

5. The utility cart of claim 1, wherein said L-shaped attachment mechanisms are coupled to undersides of said shelves; and
wherein said L-shaped attachment mechanisms further comprise at least one opening.

6. The utility cart of claim 5, wherein said posts further comprise post openings for attachment of said shelves to said cart; and
wherein said posts are attached to said shelves using post openings and said L-shaped attachment mechanisms openings.

7. The utility cart of claim 6, wherein said posts are attached to said shelves using bolts.

8. The utility cart of claim 6, wherein said posts are attached to said shelves using screws.

9. The utility cart of claim 1, wherein said cart is manufactured from stainless steel.

10. A method for assembling an utility cart, comprising the steps of:
(a) receiving a top shelf, a middle shelf and a bottom shelf;
wherein said top and middle shelves further comprise a base, three sidewalls, and a side skirt;
wherein said bottom shelf further comprises a base and four side skirts;
(b) mounting a plurality of wheels to said bottom shelf;
(c) attaching a plurality of posts to each of said shelves, wherein said posts are perpendicular to said bases of said shelves;
wherein said shelves further comprise L-shaped attachment mechanisms configured to secure said shelves and said posts in a perpendicular arrangement so that said shelves are parallel to each other; and
(d) mounting a handle coupled to two of said posts.

11. The method of claim 10, wherein said sidewalls are configured to protrude upwardly and perpendicular to said bases of said shelves;
wherein said side skirts are configured to protrude downwardly and perpendicular to said bases of said shelves.

12. The method of claim 11, further comprising a step of attaching said posts to said sidewalls and said side skirts.

13. The method of claim 11, wherein said sidewalls further comprise holding walls.

14. The method of claim 13, further comprising a step of securing posts with said holding walls to said sidewalls.

15. The method of claim 10, wherein said L-shaped attachment mechanisms are coupled to undersides of said shelves; and
wherein said L-shaped attachment mechanisms further comprise at least one opening.

16. The method of claim 15, wherein said posts further comprise post openings for attachment of said shelves to said cart; and

17. The method of claim 16, further comprising a step of attaching said posts to said shelves using post openings and said L-shaped attachment mechanisms openings.

18. The method of claim 10, further comprising a step of bolting said posts to said shelves.

19. A knockdown construction utility cart, comprising:
a top shelf, a middle shelf and a bottom shelf;
wherein said top and middle shelves further comprise a base, three sidewalls, and a side skirt;
wherein said bottom shelf further comprises a base and four side skirts;
a plurality of wheels attached to said bottom shelf;
a plurality of posts attached to each of said shelves, wherein said posts are perpendicular to said bases of said shelves;
wherein said posts are attached to said sidewalls and said side skirts;
wherein said sidewalls further comprise holding walls configured to secure said posts to said sidewalls;
wherein said shelves further comprise L-shaped attachment mechanisms configured to secure said shelves and said posts in a perpendicular arrangement so that said shelves are parallel to each other;
wherein said L-shaped attachment mechanisms are coupled to undersides of said shelves;
wherein said L-shaped attachment mechanisms further comprise at least one opening; and
wherein said posts further comprise post openings for attachment of said shelves to said cart; and
wherein said posts are attached to said shelves using post openings and said L-shaped attachment mechanisms openings.

20. The utility cart of claim 19, wherein said utility cart is manufactured from stainless steel.
